(19) United States
(12) Patent Application Publication
(10) Pub. No.: US 2010/0231365 A1
(43) Pub. Date: Sep. 16, 2010

(54) POWER LINE COMMUNICATION SYSTEM AND POWER LINE COMMUNICATION DEVICE

(76) Inventor: Toshihiko Maruoka, Osaka (JP)

Correspondence Address: MCDERMOTT WILL & EMERY LLP, 600 13TH STREET, NW, WASHINGTON, DC, 20005-3096, US

(21) Appl. No.: 12/679,398

(22) PCT Filed: Sep. 3, 2008
(86) PCT No.: PCT/JP2008/002423

§ 371 Date: Mar. 22, 2010

(30) Foreign Application Priority Data
Sep. 27, 2007 (JP) 2007 251146

(51) Int. Cl. G05B 11/01

(52) U.S. Cl. 340/310.16

(57) ABSTRACT

A controller is configured to transmit a controller receiving terminal count, or the number of terminals with which the controller can communicate, to other terminals. Each of terminals operable as a controller other than the controller transmits a signal requesting controller change to the controller and acquires controller authorization if the number of terminals with which the terminal itself can communicate is larger than the controller receiving terminal count.

### TECHNICAL FIELD

The present disclosure relates to a power line communication system using home power lines and a power line communication device used in such a power line communication system.

### BACKGROUND ART

In a power line communication system, a power line provided for supply of electric power is used as a communication medium. Therefore, noise generation and impedance fluctuations occur due to existence of an appliance connected to the power line for being supplied with electric power, and this greatly varies the transmission quality of power line communication. In particular, since the noise generation and the impedance fluctuations change only with powering ON/OFF of the appliance connected to the power line, the state of the communication (transmission quality) easily changes frequently.

Some disclosures have addressed the above problem that the transmission quality varies, in which the node with which optimal transmission quality can be obtained, or the master node, is changed dynamically, thereby to attain optimal routing easily (see Patent Document 1, for example).

### Citation List

### PATENT DOCUMENT 1: Japanese Patent No. 3693896

### SUMMARY OF THE INVENTION

### Technical Problem

In power line communication, at least one terminal in a network serves as the controller to control the communication. Therefore, variations in transmission quality caused by noise and impedance fluctuations are not a problem only for terminals between which communication is being performed. In other words, in power line communication, if one of two terminals intending to communicate with each other fails to receive a control signal from the controller, the terminals will not be able to communicate with each other because of the failure in obtaining a control signal even though the terminals are in the state of readiness to receive/transmit a signal from/to each other.

In view of the problem described above, it is an object of the present invention to ensure in power line communication that the controller can maintain communication with the maximum number of terminals even if the communication state varies.

### Solution to the Problem

To solve the problem described above, in an embodiment of the present invention, a power line communication system in which a plurality of terminals perform communication via a power line is provided,

wherein

two or more of the plurality of terminals are terminals operable as a controller that outputs a periodic signal to other terminals,

only one of the terminals operable as a controller serves as the controller at a time,

the terminals operable as the controller each transmit a test signal to other terminals,

a terminal having received the test signal issues acknowledgment of receipt of the test signal to the terminal having transmitted the test signal,

each of the terminals operable as the controller is configured to measure the number of terminals with which the terminal can communicate based on the received acknowledgment,

the controller transmits a controller receiving terminal count, which is the number of terminals with which the controller can communicate, to other terminals, and

each of the terminals operable as the controller other than the controller transmits the periodic signal and acquires controller authorization if the number of terminals with which the terminal itself can communicate is larger than the controller receiving terminal count.

In another embodiment of the present invention, a power line communication system in which a plurality of terminals perform communication via a power line is provided, wherein

two or more of the plurality of terminals are terminals operable as a controller that outputs a periodic signal,

only one of the terminals operable as a controller serves as the controller at a time,

the terminals operable as the controller each transmit a test signal to other terminals,

a terminal having received the test signal issues acknowledgment of receipt of the test signal to the terminal having transmitted the test signal,

each of the terminals operable as the controller is configured to measure an error rate from a communicating terminal using the test signal and transmit a measured value to other terminals operable as the controller,

a communication speed of a certain level or higher is required between a first terminal and a second terminal among the terminals operable as the controller, and

the first terminal or the second terminal transmits the periodic signal and acquire controller authorization if the error rate measured by the first terminal or the error rate measured by the second terminal, whichever is higher, is lower than a predetermined upper-limit error rate and the error rate measured by the terminal itself is lower than the error rate measured by the controller.

In yet another embodiment of the present invention, a power line communication system in which a plurality of terminals perform communication via a power line is provided, wherein

two or more of the plurality of terminals are terminals operable as a controller that outputs a periodic signal,

only one of the terminals operable as a controller serves as the controller at a time,

the terminals operable as the controller each transmit a test signal to other terminals,

a terminal having received the test signal issues acknowledgment of receipt of the test signal to the terminal having transmitted the test signal,

each of the terminals operable as the controller is configured to measure a reception speed of a signal from a communicating terminal using the test signal and transmit a measured value to other terminals operable as the controller,

a communication speed of a certain level or higher is required between a first terminal and a second terminal among the terminals operable as the controller, and

the first terminal or the second terminal transmits the periodic signal and acquires controller authorization if the reception speed measured by the first terminal or the reception speed measured by the second terminal, whichever is lower, is equal to or higher than a predetermined upper-limit reception speed and the reception speed measured by the terminal itself is lower than the reception speed measured by the controller.

In yet another embodiment of the present invention, a power line communication device is provided, which is used in a power line communication system in which a plurality of terminals perform communication via a power line, the device being operable as a controller that is a terminal outputting a periodic signal to other terminals, the device including:

a test signal transmission section configured to transmit a test signal to other terminals;

an receiving terminal count calculation section configured to calculate an receiving terminal count that is the number of terminals with which the device can communicate based on responses to the test signal from communicating terminals;

an receiving terminal count transmission section configured to transmit the receiving terminal count to other terminals;

a controller receiving terminal count hold section configured to hold the receiving terminal count transmitted by a terminal that is the current controller;

a controller authorization acquisition section configured, when the device is not the controller, to compare the receiving terminal count held in the controller receiving terminal count hold section to the receiving terminal count calculated in the communicating terminal calculation section, and, if the receiving terminal count calculated in the communicating terminal calculation section is larger than that held in the controller receiving terminal count hold section as a result of the comparison, generate a controller change request signal requesting that the device itself should be the controller; and

a transmission section configured to transmit the periodic signal based on the controller change request signal.

### ADVANTAGES OF THE INVENTION

According to the present invention, the controller can maintain communication with the maximum number of terminals even if the communication state varies.

### BRIEF DESCRIPTION OF THE DRAWINGS

FIG. 1 is a view showing an example of the connection relationship among power line communication devices in a power line communication system 100 of Embodiment 1.

FIG. 2 is a view showing the output timing of a reference signal and the like.

FIG. 3 is a block diagram showing a major part of the configuration of a terminal which can operate as a controller.

FIG. 4 shows a state in which an appliance 180 is newly connected to the system in the state shown in FIG. 1.

FIG. 5 is a view showing a procedure of controller change.

FIG. 6 is a view showing a flow of transmission of a reference signal/test signal (reference signal transmission task).

FIG. 7 is a view showing a flow of reception of a test signal (test signal reception task).

FIG. 8 is a view showing processing performed upon receipt of an acknowledgment signal (acknowledgment reception task).

FIG. 9 is a view showing a flow of transmission of a test signal (test signal transmission task).

FIG. 10 is a view showing a flow of controller authorization request (controller authorization request task).

FIG. 11 is a block diagram showing a major part of the configuration of a terminal which can operate as a controller.

FIG. 12 is a view showing a procedure of controller change.

FIG. 13 is a view showing a flow of transmission of a reference signal/test signal (reference signal transmission task).

FIG. 14 is a view showing a flow of reception of a test signal (test signal reception task).

FIG. 15 is a view showing processing performed upon receipt of an acknowledgment signal (acknowledgment reception task).

FIG. 16 is a view showing a flow of transmission a test signal (test signal transmission task).

FIG. 17 is a view showing a flow of controller authorization request (controller authorization request task).

FIG. 18 shows a state in which a terminal which can operate as a controller is newly connected to the system in the state shown in FIG. 1.

FIG. 19 is a view showing a procedure of controller change.

FIG. 20 shows a state in which a terminal 410 which can operate as a controller is newly connected to the system in the state shown in FIG. 18.

FIG. 21 is a view showing a procedure of controller change.

### DESCRIPTION OF REFERENCE CHARACTERS

100 Power Line Communication System
110 Terminal
111 Reception section
112 Controller Receiving Terminal Count Hold Section
113 Receiving Terminal Count Calculation Section
114 Controller Authorization Acquisition Section
115 Transmission Section
120 Terminal
130 Terminal
140 Power Line
150 Breaker
160 Appliance
170 Appliance
180 Appliance
201 Controller Reception State Hold Section
202 Reception State Calculation Section
310 Terminal
410 Terminal

### DESCRIPTION OF EMBODIMENTS

Embodiments of the present invention will be described with reference to the accompanying drawings. Note that in the description of the embodiments to follow, components having similar functions to those already described are denoted by the same reference numerals and description thereof is omitted.

### Embodiment 1

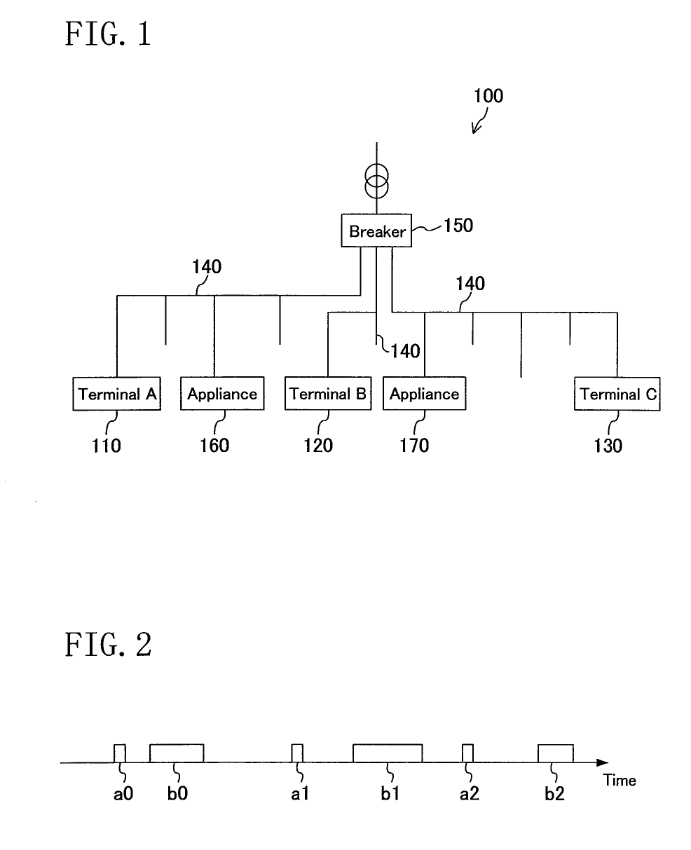

FIG. 1 is a view showing an example of the connection relationship among power line communication devices (hereinafter referred to as terminals) in a power line communication system 100 of Embodiment 1 of the present invention. In the illustrated example, terminals 110, 120, and 130 (respectively shown as terminals A, B, and C in FIG. 1) that perform power line communication are connected to one another via a power line 140. The power line 140 includes a plurality of systems, through which electric power is supplied from the outdoors via a breaker 150.

In the illustrated example, appliances 160 and 170 that do not perform power line communication but operate with electric power supplied via the power line 140 are also connected to the power line 140.

(Configuration of Terminals)

The terminal 130, among the terminals 110, 120, and 130, is a terminal which cannot operate as a controller.

On the contrary, the terminals 110 and 120 are terminals which can operate as a controller in power line communication. It is assumed that only one terminal can be a controller at a time in the power line communication system 100.

The terminals which can operate as the controller each have a function of outputting a time reference signal periodically. FIG. 2 is a view illustrating the output timing of the reference signal and the like. In FIG. 2, a0, a1 and a2 denote the reference signal output periodically from the controller, and b0, b1 and b2 denote communication signals between terminals.

Also, each of the terminals which can operate as the controller is supposed to perform the following when the terminal itself is not the controller: it compares the number of terminals with which the current controller can communicate to the number of terminals with which the terminal itself can communicate, and acquires controller authorization if the latter is larger than the former. To achieve this, each of the terminals which can operate as the controller is configured as follows.

First, the terminal which can operate as the controller is configured to output a test signal together with the reference signal. In relation to this, the terminals in the power line communication system 100 (both the terminals which can operate and cannot operate as the controller) are configured to output an acknowledgment signal in response to the test signal.

Secondly, the terminal which can operate as the controller is configured to calculate the number of terminals with which the terminal itself can communicate (receiving terminal count) based on received acknowledgment signals and transmit the calculated receiving terminal count.

The timing at which a terminal starts output of a test signal is different between when the terminal is serving as the controller and when it is not. In other words, when serving as the controller, the terminal outputs a test signal together with the reference signal at fixed intervals (hereinafter referred to as the test signal issuance period). When not serving as the controller, the terminal outputs a test signal in the test signal issuance period once having received the receiving terminal count from the controller.

Having the configuration described above, the terminal which can operate as the controller can acquire the number of terminals with which the current controller can communicate and the number of terminals with which the terminal itself can communicate.

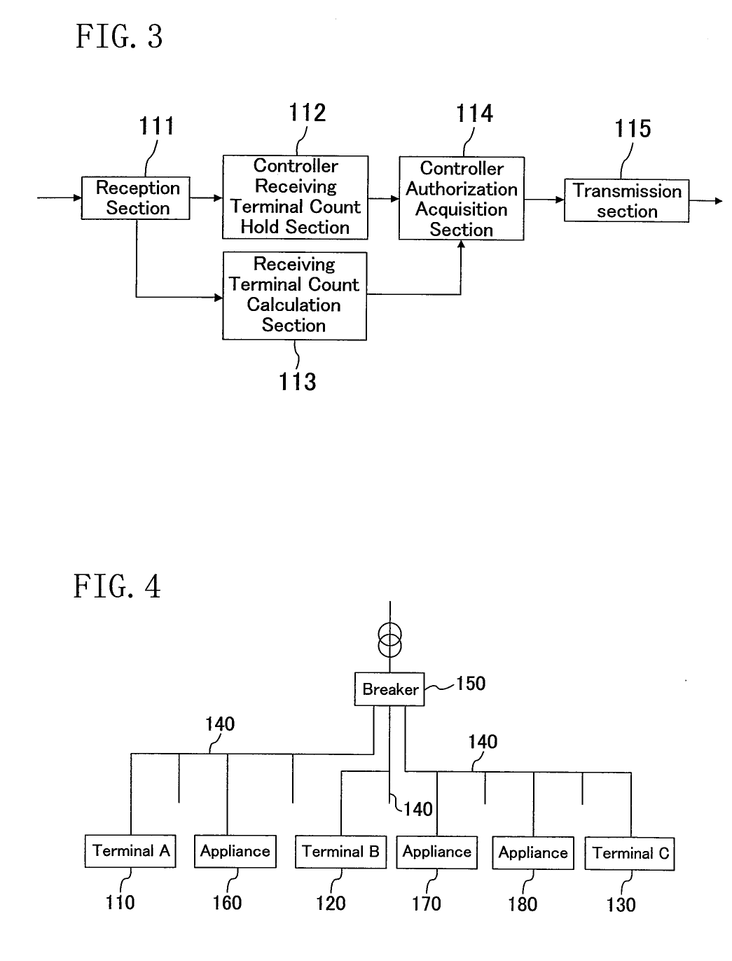

FIG. 3 is a block diagram showing a major part of the terminal which can operate as the controller. As shown in FIG. 3, the terminal which can operate as the controller includes a reception section 111, a controller receiving terminal count hold section 112, a receiving terminal count calculation section 113, a controller authorization acquisition section 114, and a transmission section 115.

The reception section 111 is configured to receive the reference signal and a communication signal via the power line 140.

The controller receiving terminal count hold section 112 is configured to hold the receiving terminal count received from the controller.

The receiving terminal count calculation section 113 is configured to calculate the receiving terminal count based on the number of acknowledgment signals received within a set time from the start of transmission of the test signal.

The controller authorization acquisition section 114 is configured to compare the receiving terminal count held in the controller receiving terminal count hold section 112 (the receiving terminal count of the controller) to the receiving terminal count calculated in the receiving terminal count calculation section 113, and if the latter is larger than the former, generate a signal requesting controller authorization (a controller change request signal) and instruct the transmission section 115 to transmit a signal that the controller should transmit to other terminals periodically. In this example, the controller authorization acquisition section 114 instructs the transmission section 115 to transmit the reference signal.

The transmission section 115 is configured to transmit a communication signal and the reference signal via the power line 140.

(Operation of Terminals in Power Line Communication System 100)

A procedure of controller change in the power line communication system 100 will be described taking as an example a case where connection of a new appliance to the power line 140 causes failure in communication of some of the terminals in the system with the controller.

For example, assume that in the state shown in FIG. 1, the terminal 110 serves as the controller and communication is possible between the terminals 110 and 120 and between the terminals 110 and 130.

FIG. 4 shows a state in which an appliance 180 is newly connected to the system in the state shown in FIG. 1. In the state shown in FIG. 4, assume that noise has increased with this connection of the appliance 180, and this has caused failure in communication between the terminals 110 and 130, whereby the terminal 130 can no more receive the reference signal. Note that, in the state shown in FIG. 4, communication is possible between the terminals 110 and 120 and between the terminals 120 and 130.

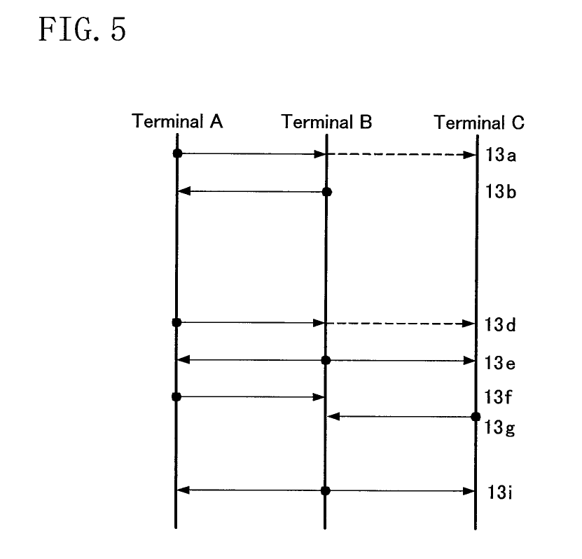

In the state described above, the power line communication system 100 performs communication according to a procedure illustrated in FIG. 5, to change the controller.

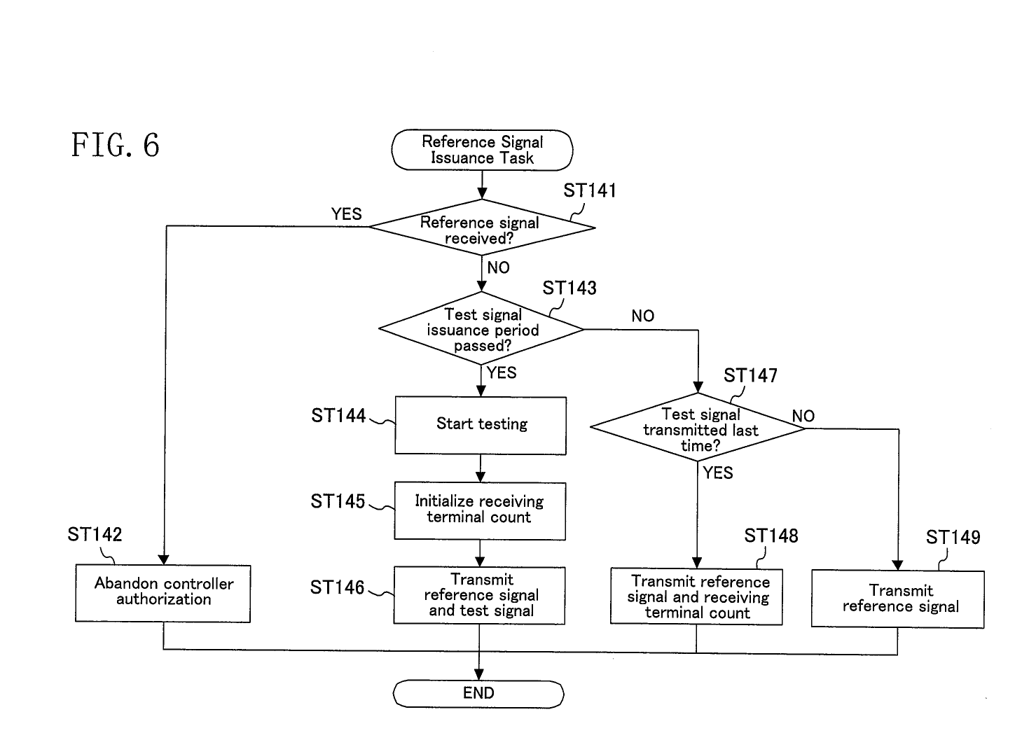

First, the controller transmits the reference signal and a test signal to the terminals (see step 13a in FIG. 5). More specifically, the controller transmits the reference signal and a test signal according to a flow (reference signal issuance task) shown in FIG. 6.

In step ST141 shown in FIG. 6, the controller determines whether it is allowed to hold controller authorization. More specifically, the controller tries to receive the reference signal and, if having received the reference signal, determines that it should abandon controller authorization. When the abandonment is determined, the process moves to step ST142 to abandon controller authorization.

If having not received the reference signal, the controller performs a series of processing in and after step ST143 to obtain the receiving terminal count.

In step ST143, whether the test signal issuance period has passed is determined. If it has passed, the process moves to step ST144, where testing on whether controller change is necessary or not is started.

More specifically, the controller (terminal 110) first initializes the receiving terminal count (step ST145), and then transmits the reference signal and a test signal from its transmission section 115 (step ST146).

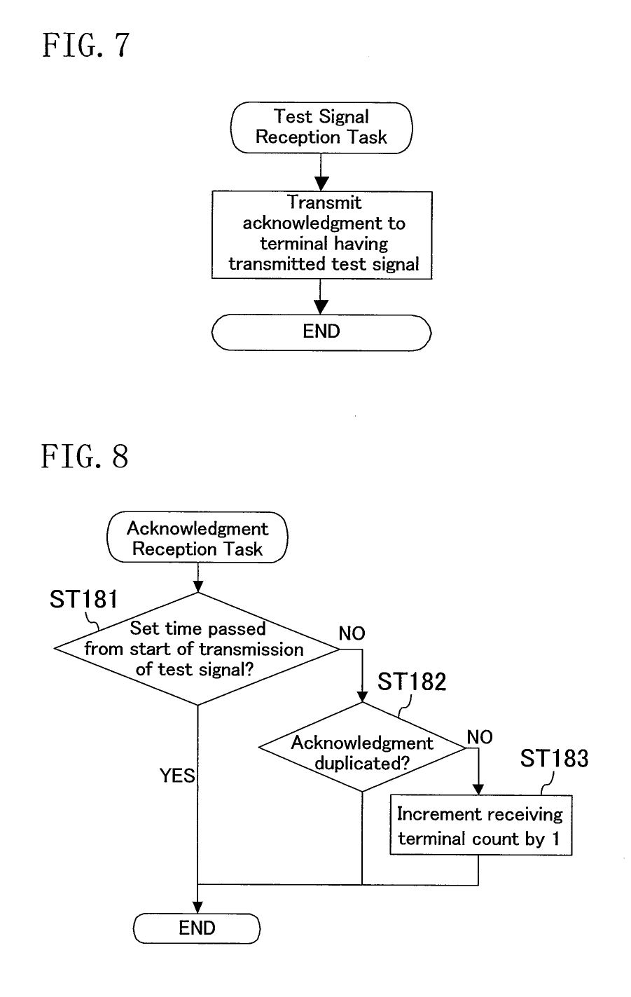

In this example, the terminal 120 can receive the test signal. Therefore, the terminal 120 transmits an acknowledgment signal to the terminal 110 in response to the test signal according to a flow (test signal reception task) shown in FIG. 7 (see step 13b in FIG. 5). On the contrary, the terminal 130, which cannot receive the test signal from the terminal 110 in this example, does not react.

Once having received the acknowledgment signal from the terminal 120, the controller (terminal 110) executes a flow (acknowledgment reception task) shown in FIG. 8. That is, in step ST181, the controller examines whether a set time has passed from the start of transmission of the test signal. If it has passed, the acknowledgment reception task is terminated.

If the set time has not passed, whether there is no duplication of the acknowledgment signal is examined (step ST182). If there is no duplication, the receiving terminal count is incremented by one (step ST183). In this example, the receiving terminal count is 1. If there is duplication, the acknowledgment reception task is terminated.

Subsequently, the controller (terminal 110) executes the reference signal issuance task (see FIG. 6) again after the lapse of a fixed time from the last test signal issuance. In this example, since the controller has not received the reference signal and the test signal issuance period has not passed, a series of processing in and after step ST147 is executed.

In the step ST147, whether or not a test signal was transmitted in the last reference signal issuance task is examined. In this example, since a test signal was transmitted in the last reference signal issuance task, the process moves to step ST148, where the reference signal and the receiving terminal count (1 in this example) are transmitted (see step 13d in FIG. 5). If no test signal was transmitted in the last reference signal issuance task, the process moves to step ST149 to transmit only the reference signal.

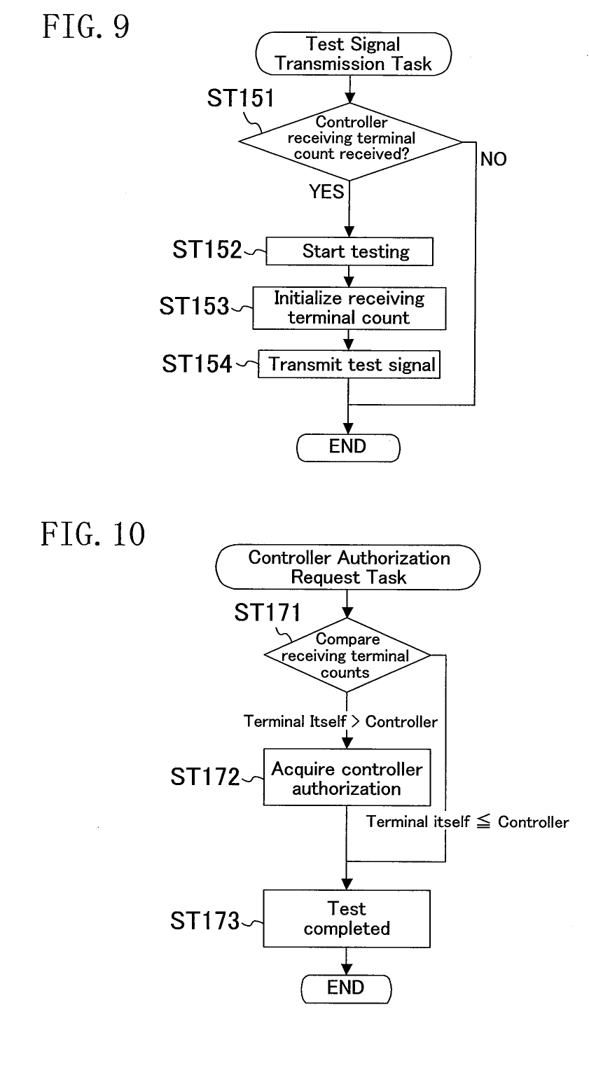

The terminal 120, having received the receiving terminal count transmitted by the controller, holds the receiving terminal count in its controller receiving terminal count hold section 112. Also, the terminal 120 transmits a test signal once having received the receiving terminal count from the controller (see step 13e in FIG. 5). More specifically, the terminal 120 executes a flow (test signal transmission task) shown in FIG. 9. As shown in FIG. 9, the terminal 120 determines whether having received the receiving terminal count from the controller (step ST151).

If having received the receiving terminal count from the controller, the terminal 120 starts testing on whether controller change is necessary or not (step ST152). More specifically, the terminal 120 first initializes the receiving terminal count (step ST153), and then transmits a test signal from its transmission section 115 (step ST154).

In response to the above, the terminals 110 and 130 each execute the test signal reception task (see FIG. 7) and transmit an acknowledgment signal to the terminal 120 (see steps 13f and 13g in FIG. 5).

In response to the above, the terminal 120 executes the acknowledgment reception task (see FIG. 8). That is, the terminal 120 calculates the receiving terminal count in its receiving terminal count calculation section 113. In this example, the receiving terminal count is 2 (the terminals 110 and 130).

Once having calculated the receiving terminal count in its receiving terminal count calculation section 113, the terminal 120 executes a flow (controller authorization request task) shown in FIG. 10. That is, the controller authorization acquisition section 114 of the terminal 120 compares the receiving terminal count calculated in the receiving terminal count calculation section 113 to the receiving terminal count held in the controller receiving terminal count hold section 112 (step ST171).

If the receiving terminal count of the terminal itself (terminal 120) is larger than that of the controller, the process moves to step ST172. If the receiving terminal count of the terminal 120 is equal to or less than that of the controller, the process moves to step ST173 to terminate the testing.

In the step ST172, the controller authorization acquisition section 114 instructs the transmission section 115 to transmit the reference signal as the signal requesting controller authorization.

In this example, since the receiving terminal count of the terminal 120 is larger than that of the controller, the terminal 120 outputs the reference signal as the signal requesting controller authorization thereby to acquire authorization as the controller.

The terminal as the new controller (terminal 120) then executes the reference signal issuance task (see FIG. 6) to transmit the reference signal and the receiving terminal count (step ST148 and step 13i in FIG. 5).

The terminal 110 also executes the reference signal issuance task (see FIG. 6). However, since the terminal as the new controller (terminal 120) has transmitted the reference signal, the terminal 110 determines as having received the reference signal in step ST141, and thus abandons controller authorization (step ST142).

Hence, the terminal 120 becomes the controller, and this permits the controller 130 to communicate with the controller (i.e., the terminal 120).

When there are three or more terminals which can operate as the controller, a terminal of which the receiving terminal count is not the largest among those of the terminals may happen to acquire controller authorization depending on the operation timing of these terminals. However, such a controller, which also executes the reference signal issuance task to transmit the reference signal and the receiving terminal count, will be replaced by a terminal that is larger in receiving terminal count than the controller, if any.

In other words, in the end, a terminal largest in receiving terminal count among the terminals which can operate as the controller will become the controller.

As described above, in this embodiment, in which only a terminal largest in the number of terminals with which the terminal can communicate becomes the controller, communication with the maximum number of terminals can be maintained even if the communication state varies. Also, since it is unnecessary to increase the number of controllers, the communication band is kept from decreasing.

### Embodiment 2

In Embodiment 2 of the present invention, an example of a power line communication system in which the controller is determined considering the reception state in addition to the receiving terminal count will be described.

In this embodiment, also, FIG. 1 is referred to as an example of the communication relationship among the power line and the terminals.

(Configuration of Terminals)

In this embodiment, in the case that the receiving terminal count of the current controller and the receiving terminal count of a non-controller terminal which can operate as the controller are the same, the non-controller terminal which can operate as the controller will acquire controller authorization if the highest error rate in communication between the terminal itself and other terminals is lower than the highest error rate in communication between the current controller and other terminals.

To achieve this, first, the terminals in the power line communication system are configured to transmit an error rate for a test signal in addition to an acknowledgment signal.

In addition, the terminals which can operate as the controller are configured to hold the highest one of error rates received from other terminals.

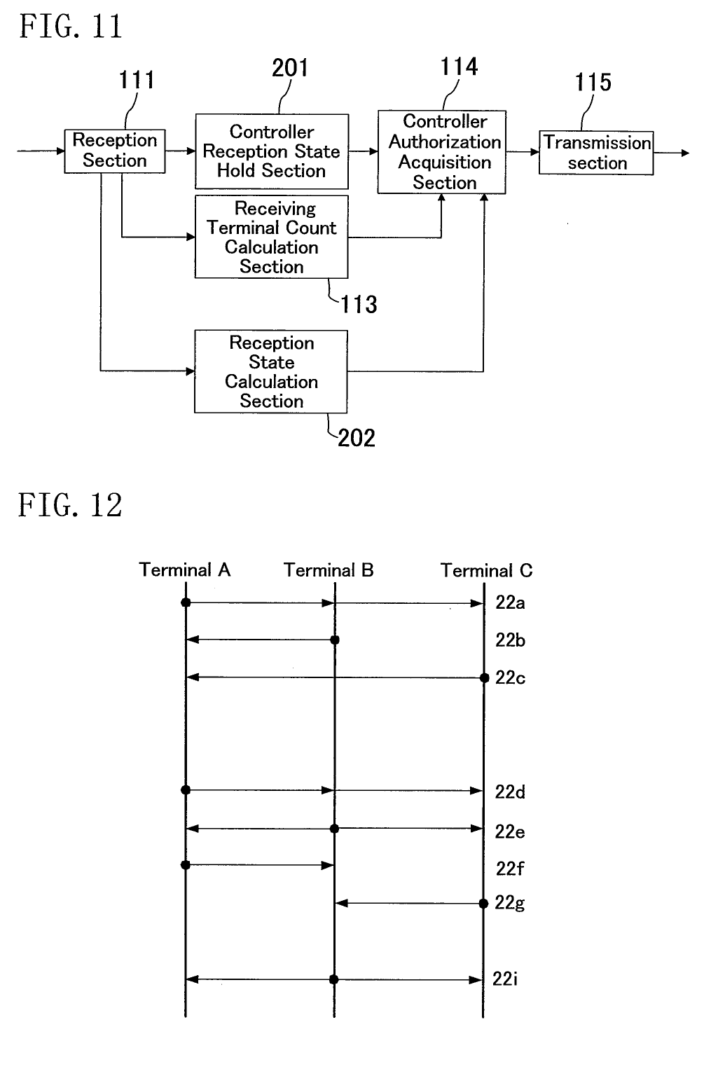

FIG. 11 is a block diagram showing a major part of a terminal which can operate as the controller. As shown in FIG. 11, the terminal which can operate as the controller includes a reception section 111, a receiving terminal count calculation section 113, a controller authorization acquisition section 114, a transmission section 115, a controller reception state hold section 201, and a reception state calculation section 202.

The reception state calculation section 202 is configured to hold the highest one of error rates received from other terminals.

The controller reception state hold section 201 is configured to hold the receiving terminal count and the highest error rate received from the controller.

Having the configuration described above, the terminal which can operate as the controller can compare the highest error rate in communication between the current controller and other terminals to the highest error rate in communication between the terminal itself and other terminals.

(Operation of Each Terminal in This Embodiment)

A procedure of controller change will be described assuming that the terminal 110 is the current controller and the terminals 120 and 130 can receive a test signal issued by the terminal 110 in the connection state shown in FIG. 1.

In the state described above, the power line communication system performs communication according to a procedure illustrated in FIG. 12, to change the controller.

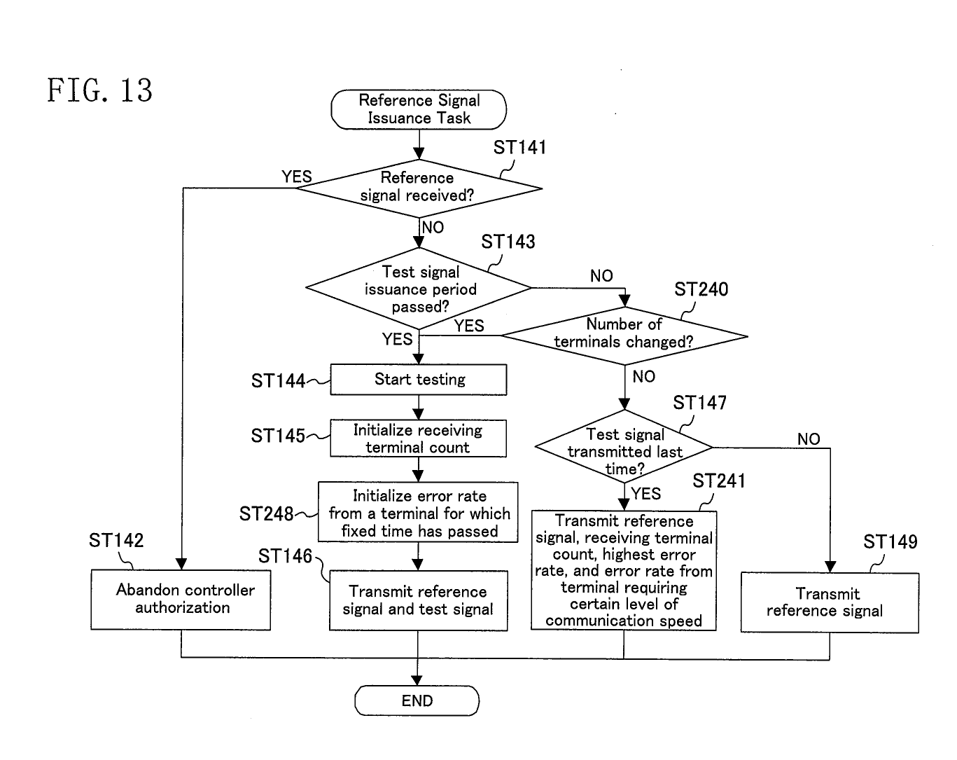

First, the controller (terminal 110) transmits the reference signal and a test signal to the terminals (see step 22a in FIG. 12). More specifically, the controller transmits the reference signal and a test signal according to a flow (reference signal issuance task) shown in FIG. 13.

In step ST141 shown in FIG. 13, the controller determines whether it is allowed to hold controller authorization. More specifically, the controller tries to receive the reference signal and, if having received the reference signal, determines that it should abandon controller authorization. When the abandonment is determined, the process moves to step ST142 to abandon controller authorization.

If having not received the reference signal, the controller performs a series of processing in and after step ST143 to obtain the receiving terminal count.

In step ST143, whether the test signal issuance period has passed is determined. If it has passed, the process moves to step ST144, where testing on whether controller change is necessary or not is started.

More specifically, the controller (terminal 110) first initializes the receiving terminal count (step ST145). Thereafter, error rates from other terminals for the last test signal for which a fixed time has passed from issuance are initialized (step ST248). The reference signal and a test signal are then transmitted from the transmission section 115 (step ST146).

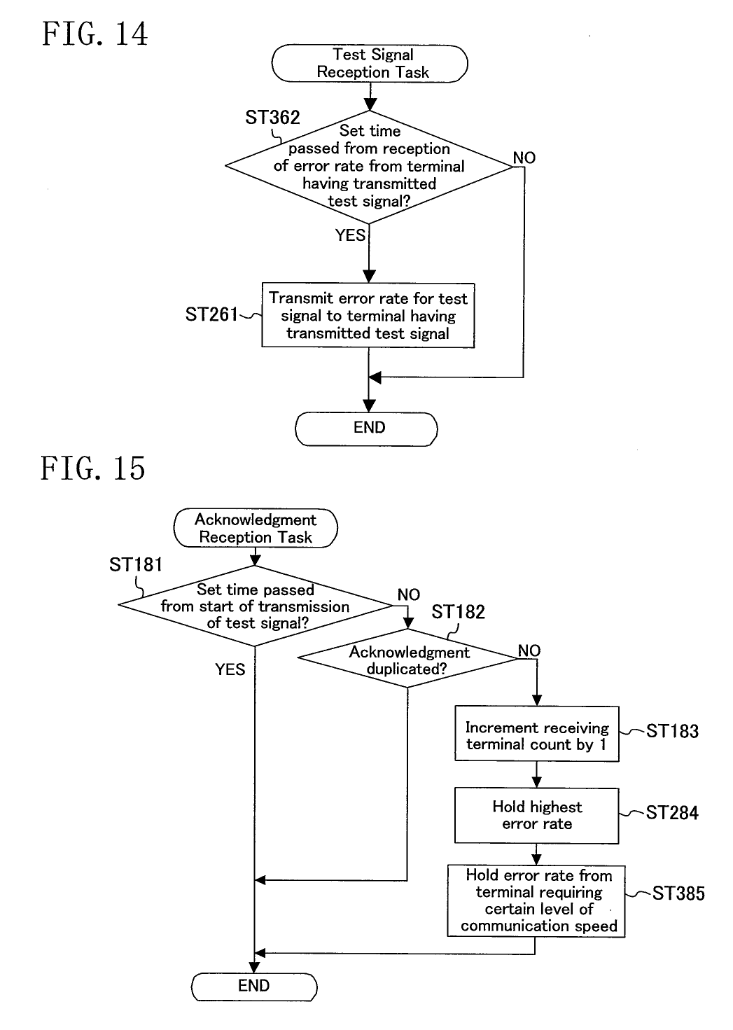

In this example, the terminals 120 and 130 can receive the test signal. Therefore, the terminals 120 and 130 transmit an acknowledge signal and an error rate to the terminal 110 in response to the test signal according to a flow (test signal reception task) shown in FIG. 14 (see steps 22b and 22c in FIG. 12). More specifically, each of the terminals 120 and 130 checks whether a predetermined time has passed after receipt of an error rate from the terminal having transmitted the test signal (step ST362). If the predetermined time has passed, the terminal transmits an error rate to the terminal having transmitted the test signal (step ST261).

Once receiving the acknowledgment signal and the error rate from the terminals 120 and 130, the controller (terminal 110) executes a flow (acknowledgment reception task) shown in FIG. 15. That is, in step ST181, the controller examines whether a set time has passed from the start of transmission of the test signal. If it has passed, the acknowledgment reception task is terminated.

If the set time has not passed, whether there is no duplication of the acknowledgment signal is examined (step ST182). If there is no duplication, the receiving terminal count is incremented by one (step ST183). In this example, the receiving terminal count is 2 (the terminals 120 and 130). Thereafter, the highest one of the error rates is held in the reception state calculation section 202 (step ST284). For example, assuming that the terminal 130 is located farthest in terms of communication and as a result highest in error rate, the error rate from the terminal 130 is held in the reception state calculation section 202.

Subsequently, the controller (terminal 110) executes the reference signal issuance task (see FIG. 13) again after the lapse of a fixed time from the last test signal issuance. Since the controller has not received the reference signal and the test signal issuance period has not passed, a series of processing in and after step ST240 is executed.

In step ST240, whether the number of terminals has changed is determined. If it has changed, the process moves to the processing in step ST144, and if it has not changed, the process moves to the processing in step ST147.

A flow to be followed when the number of terminals has not changed will be described (a flow to be followed when it has changed will be described later).

In step ST147, whether a test signal was transmitted in the last reference signal issuance task is checked. In this example, since a test signal was transmitted in the last reference signal issuance task, the process moves to step ST241, where the reference signal, the receiving terminal count (2 in this example), and the highest error rate are transmitted (see step 22d in FIG. 12). If no test signal was transmitted in the last reference signal issuance task, the process moves to step ST149 to transmit only the reference signal.

The terminals 120 and 130, having received the receiving terminal count and the highest error rate transmitted by the controller, hold these values in their controller reception state hold sections 201.

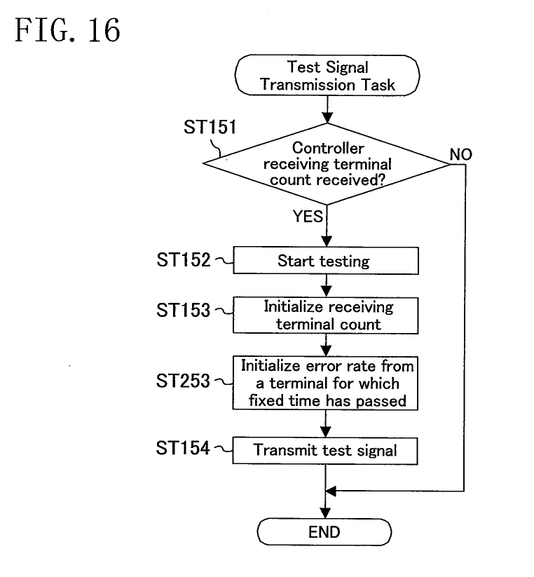

The terminal 120, having received the receiving terminal count and the highest error rate from the controller, transmits a test signal (see step 22e in FIG. 12). More specifically, the terminal 120 executes a flow (test signal transmission task) shown in FIG. 16. That is, the terminal 120 determines whether having received the receiving terminal count from the controller (step ST151).

If having received the receiving terminal count from the controller, the terminal 120 starts testing on whether controller change is necessary or not (step ST152). More specifically, the terminal 120 first initializes the receiving terminal count (step ST153), and then initializes error rates from other terminals for the last test signal for which a fixed time has passed from issuance (step ST253). Thereafter, the terminal 120 transmits a test signal from its transmission section 115 (step ST154).

The terminals 110 and 130 then execute the test signal reception task (see FIG. 14) and transmit an acknowledgment signal to the terminal 120 (see steps 22f and 22g in FIG. 12).

In response to the above, the terminal 120 executes the acknowledgment reception task (see FIG. 15). That is, the terminal 120 calculates the receiving terminal count in the receiving terminal count calculation section 113. In this example, the receiving terminal count is 2 (the terminals 110 and 130).

The terminal 120 also holds the highest error rate among the received error rates in the reception state calculation section 202. For example, if the terminal 130 is located farthest in terms of communication and as a result highest in error rate, the error rate from the terminal 130 is held in the reception state calculation section 202.

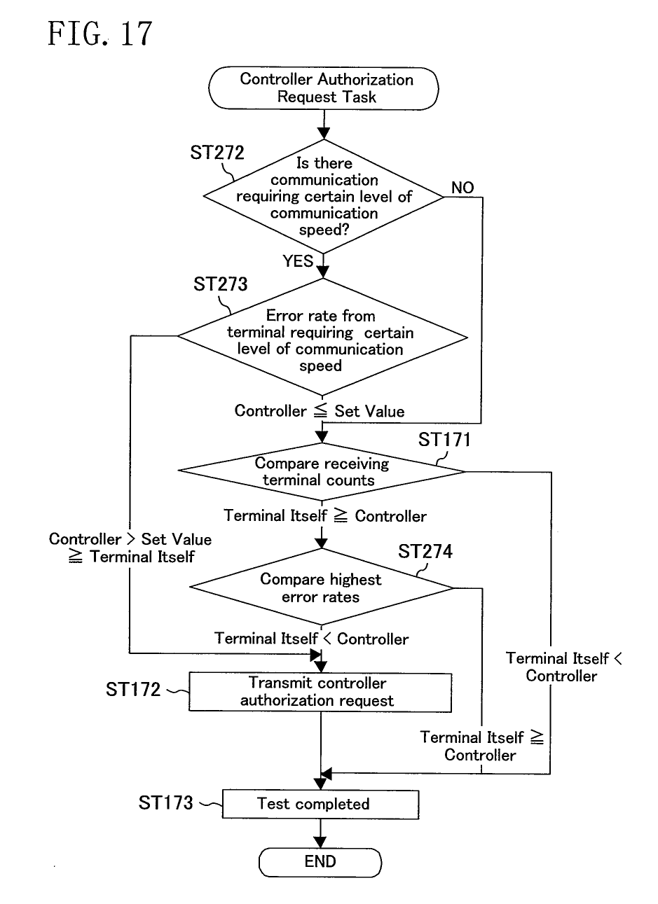

Once having calculated the receiving terminal count and the highest error rate, the terminal 120 executes a flow (controller authorization request task) shown in FIG. 17. More specifically, the controller authorization acquisition section 114 of the terminal 120 compares the receiving terminal count calculated in the receiving terminal count calculation section 113 to the receiving terminal count held in the controller reception state hold section 201 (step ST171).

If the receiving terminal count of the terminal itself (terminal 120) is equal to or larger than that of the controller, the process moves to step ST274. Conversely, if the receiving terminal count of the terminal 120 is smaller than that of the controller, the process moves to step ST173 to terminate the testing.

In step ST274, the highest error rate held in the reception state calculation section 202 is compared to the highest error rate held in the controller reception state hold section 201.

As a result of the comparison, if the highest error rate of the terminal itself (terminal 120) is lower than the highest error rate of the controller, the process moves to step ST172. Conversely, if the receiving terminal count of the terminal 120 is smaller than that of the controller, the process moves to step ST173 to terminate the testing.

In the step ST172, the controller authorization acquisition section 114 instructs the transmission section 115 to transmit the reference signal as the signal requesting controller authorization.

In this example, since the receiving terminal count of the terminal itself (terminal 120) is 2, which is equal to that of the controller, step ST274 is executed.

When the highest error rate of the terminal itself is lower than that of the controller, for example, from the comparison in step ST274, the terminal 120 outputs the reference signal as the signal requesting controller authorization, thereby to acquire authorization as the controller.

The terminal 120 as the new controller then executes the reference signal issuance task (see FIG. 13) to transmit the reference signal, the receiving terminal count, and the highest error rate (see step ST241 and step 22i in FIG. 12).

The terminal 110 also executes the reference signal issuance task (see FIG. 13). However, since the terminal as the new controller (terminal 120) has transmitted the reference signal, the terminal 110 determines as having received the reference signal in step ST141, and thus abandons controller authorization (step ST142).

Hence, the terminal 120 becomes the controller, and this minimizes the error rate in communication with the controller.

In other words, in this embodiment, a terminal largest in receiving terminal count can be set as the controller, and moreover the error rate can be minimized. This permits more stable communication.

(Operation Executed in Response to Change in Number of Terminals in Power Line Communication System)

In the power line communication system of Embodiment 2, the controller may be configured to output a test signal when the number of terminals in the power line communication system has changed. This permits assignment of a terminal at an optimal position as the controller in response to a change in the number of terminals.

In the example to follow, it is configured that a terminal having communicated with the controller within a fixed time does not need to issue acknowledgment of the test signal. With this configuration, decrease in communication band due to issuance of a test signal can be minimized.

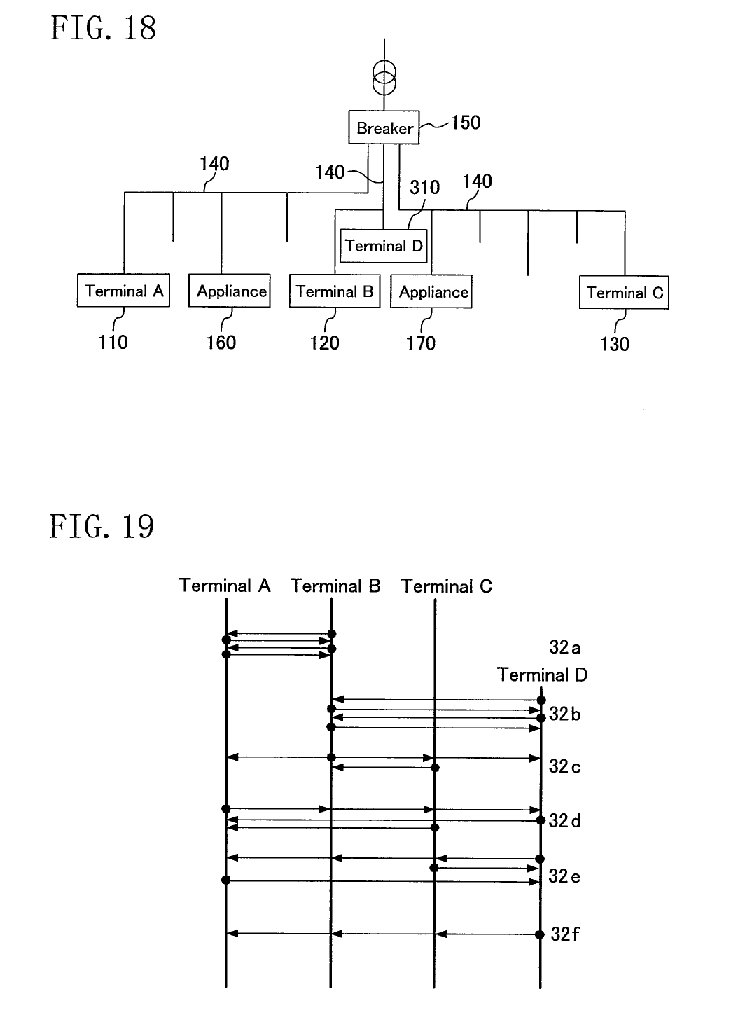

FIG. 18 shows a case where a terminal 310 (terminal D in FIG. 18) which can operate as the controller is newly connected to the system in the state shown in FIG. 1. The operation of the terminals will be described taking this case as an example. In this state, the power line communication system performs communication according to a procedure illustrated in FIG. 19, to change the controller.

In this example, assume that, before connection of the terminal 310, the terminals 110 and 120 have been communicating with each other, and hold each other's error rates (see step 32a in FIG. 19).

First, the terminal 310 joins the network and communicates with the controller (terminal 120). The terminals 310 and 120 hold each other's error rates (see step 32b in FIG. 19).

Since the number of terminals has changed, the controller (terminal 120) issues a test signal together with the reference signal at the time of reference signal issuance (see step ST240 in FIG. 13 and step 32c in FIG. 19).

The terminals 110 and 310, which hold the error rate from the terminal 120, do not respond to this test signal. Meanwhile, the terminal 130 transmits an error rate to the terminal 120 (see step 32c in FIG. 19).

Thus, the controller (terminal 120) holds the highest error rate and the receiving terminal count.

In this example, the terminal 120 holds the receiving terminal count=3 (the terminals 110, 130, and 310). Also, assuming that the error rate from the terminal 130 is highest, for example, the terminal 120 holds the error rate from the terminal 130. The terminal 120 then transmits these values held therein to other terminals.

When having received the receiving terminal count and the highest error rate from the controller (terminal 120), any terminal which can operate as the controller other than the terminal currently serving as the controller transmits a test signal.

In this example, the terminal 110 transmits a test signal and receives error rates from the terminals 130 and 310 (step 32d in FIG. 19). The terminal 310 also transmits a test signal and likewise receives error rates from the terminals 110 and 130 (see step 32e in FIG. 19).

Any terminal which can operate as the controller other than the terminal currently serving as the controller compares the receiving terminal count of the terminal itself to the receiving terminal count of the controller, and further compares the highest error rate of the terminal itself to the highest error rate of the controller. If the terminal determines that the terminal itself should become the controller from the comparison results, it acquires controller authorization.

For example, assume that the terminal 310 is larger in receiving terminal count than the controller and lower in highest error rate than the controller because the terminal is located near the other terminals in terms of communication. In this case, the terminal 310 acquires controller authorization and transmits the reference signal, the receiving terminal count (3 in this example), and the highest error rate (see step 32f in FIG. 19).

As described above, a terminal at an optimal position can be assigned as the controller in response to a change in the number of terminals.

### Embodiment 3

In Embodiment 3 of the present invention, an example of a power line communication system capable of securing a communication speed of a certain level or higher between predetermined terminals will be described. To achieve this, the system should be configured as follows.

First, in this embodiment, as in the above embodiment, the terminals in the power line communication system are configured to transmit an error rate for a test signal in addition to an acknowledgment signal.

The terminals which can operate as the controller can set an upper-limit value of the error rate (upper-limit error rate) allowable to secure a communication speed of a certain level or higher.

The terminals which can operate as the controller are also configured to hold the highest one of error rates received from other terminals.

Also, in this embodiment, as in the above embodiment, the controller outputs a test signal when the number of terminals in the power line communication system has changed.

(Operation of Terminals)

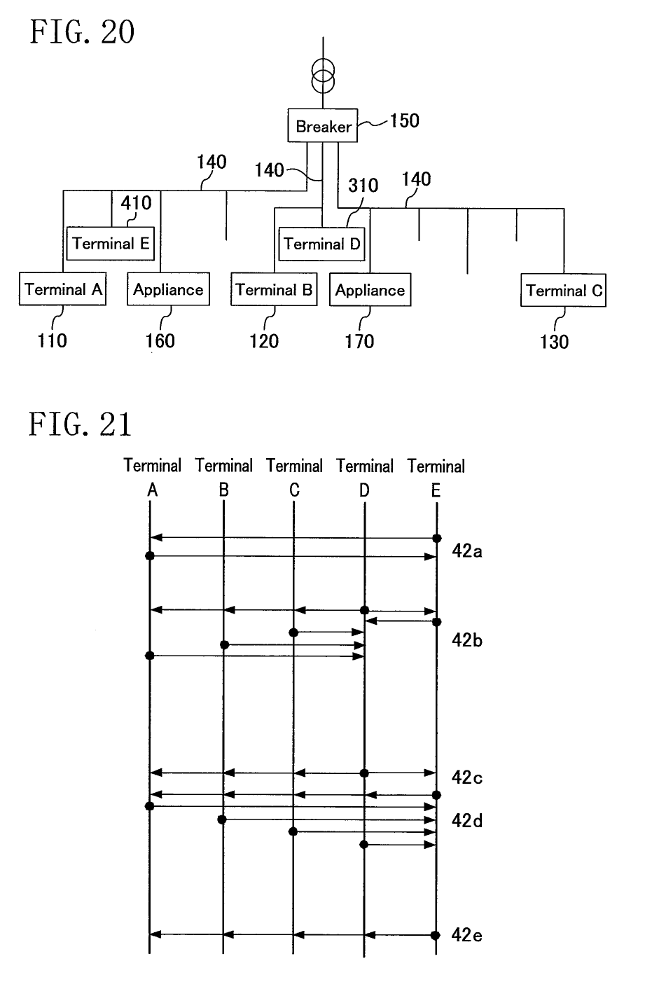

FIG. 20 shows a state where a terminal 410 (terminal E in FIG. 20) is newly connected to the system in the state shown in FIG. 18. Assume that a communication speed of a certain level or higher is required between the terminals 110 and 410. An example of such communication requiring a communication speed of a certain level or higher includes transmission of images, for example. Assume also that the terminal 410 is which can operate as the controller and the current controller is the terminal 310.

In this power line communication system, communication is performed according to a procedure illustrated in FIG. 21, to change the controller.

First, the terminal 410 joins the network and communicates with the terminal 110 (see step 42a in FIG. 21). This communication requires a communication speed of a certain level or higher.

Since the number of terminals has changed with the terminal 410 having joined the network, the terminal 310 transmits the reference signal and a test signal to other terminals, and then receives error rates from the terminals (see step 42b in FIG. 21).

The terminal 310 transmits the highest error rate among the error rates transmitted from the other terminals and the set upper-limit error rate (step 42c in FIG. 21).

In this example, assume that the error rate between the controller and the terminal 110 is higher than the upper-limit error rate.

In the above case where the error rate between the controller and the terminal 110 is larger than the set upper-limit error rate, the terminal 410 transmits a test signal. In response to this, other terminals transmit their error rates for the test signal to the terminal 410 (see step 42d in FIG. 21).

If the error rate from the terminal 110 is lower than the upper-limit error rate, the terminal 410 acquires controller authorization. The controller 410 then transmits the reference signal, the highest error rate, and the upper-limit error rate (see step 42e in FIG. 21).

As a result, the error rate is lower than the upper-limit error rate in the communication between the terminals 410 and 110. In other words, it is possible to secure a communication speed of a certain level or higher in the communication between the terminals 410 and 110.

### Other Embodiments

In Embodiment 2, a terminal acquires controller authorization when the highest one of error rates of the terminal itself is lower than the highest one of error rates of the controller. Alternatively, controller authorization may be acquired when the average of error rates of the terminal itself is lower than that of the controller, or when the average of logarithms of error rates of the terminal itself is lower than that of the controller. Although the average of error rates and the average of logarithms of error rates are more complicated to compute, the average reception speed through the transmission route can be further increased by adopting such values.

In Embodiments 2 and 3, which terminal should acquire controller authorization is determined based on the error rates. Alternatively, the determination can be made using the lowest one of reception speeds, the average of reception speeds, or the average of logarithms of reception speeds. In this case, a terminal highest in the lowest one of reception speeds, the average of reception speeds, or the average of logarithms of reception speeds will become the controller. Although these are complicated to compute, it is possible to obtain the effect that computation can be made with actual reception speeds.

The reference signal described in the embodiments is not limited to the time reference signal. It may be any signal issued by the controller generally periodically, such as time management information for schedule management, for example. In this case, also, a similar advantage will clearly be gained.

The number of terminals in the power line communication system is not limited to that described in the above examples. The number of terminals may specifically be three or more, and two or more of these terminals may be operable as the controller. As long as these are satisfied, a similar advantage will clearly be gained.

In Embodiments 2 and 3, whether to change the controller is examined when the number of terminals increases, but whether to change the controller may be examined when the number of terminals decreases, where a similar advantage will clearly be gained.

Whether to change the controller may be examined when a terminal, among the terminals belonging to a network, has failed to receive the reference signal from the controller for a fixed time or longer. This will produce the effect of being responsive to a change in the state of the network. More specifically, if any of the terminals which can operate as the controller other than the current controller has failed to receive the reference signal from the controller for a fixed time or longer, the terminal in question may output a test signal to examine whether to change the controller.

### INDUSTRIAL APPLICABILITY

The power line communication system of the present invention has the effect that the controller can maintain communication with the maximum number of terminals even if the communication state has changed. Hence, the present invention is useful in a power line communication system using home power lines and a power line communication device and the like used in such a power line communication system.

1. A power line communication system in which a plurality of terminals perform communication via a power line,
wherein
two or more of the plurality of terminals are terminals operable as a controller that outputs a periodic signal to other terminals,
only one of the terminals operable as a controller serves as the controller at a time,
the terminals operable as the controller each transmit a test signal to other terminals,
a terminal having received the test signal issues acknowledgment of receipt of the test signal to the terminal having transmitted the test signal,
each of the terminals operable as the controller is configured to measure the number of terminals with which the terminal can communicate based on the received acknowledgment,
the controller transmits a controller receiving terminal count, which is the number of terminals with which the controller can communicate, to other terminals, and
each of the terminals operable as the controller other than the controller transmits the periodic signal and acquires controller authorization if the number of terminals with which the terminal itself can communicate is larger than the controller receiving terminal count.

2. The system of claim 1, wherein
each of the terminals operable as the controller is configured to measure an average of reception speeds of signals from communicating terminals, or an average of logarithms of the reception speeds, using the test signal, and
when the number of terminals with which the terminal itself can communicate is the same as the controller receiving terminal count, each of the terminals operable as the controller other than the controller transmits the periodic signal and acquires controller authorization if a value measured by the terminal is larger than a value measured by the controller.

3. The system of claim 1, wherein
each of the terminals operable as the controller is configured to measure an average of error rates from communicating terminals, or an average of logarithms of the error rates, using the test signal, and
when the number of terminals with which the terminal itself can communicate is the same as the controller receiving terminal count, each of the terminals operable as the controller other than the controller transmits the periodic signal and acquires controller authorization if a value measured by the terminal is smaller than a value measured by the controller.

4. The system of claim 1, wherein
each of the terminals operable as the controller is configured to measure a reception speed of a signal from a communicating terminal using the test signal, and
when the number of terminals with which the terminal itself can communicate is the same as the controller receiving terminal count, each of the terminals operable as the controller other than the controller transmits the periodic signal and acquires controller authorization if a value measured by the terminal is larger than a value measured by the controller.

5. The system of claim 1, wherein
each of the terminals operable as the controller is configured to measure an error rate from a communicating terminal using the test signal, and
when the number of terminals with which the terminal itself can communicate is the same as the controller receiving terminal count, each of the terminals operable as the controller other than the controller transmits the periodic signal and acquires controller authorization if the highest value measured by the terminal is smaller than a value measured by the controller.

6. A power line communication system in which a plurality of terminals perform communication via a power line,
wherein
two or more of the plurality of terminals are terminals operable as a controller that outputs a periodic signal,
only one of the terminals operable as a controller serves as the controller at a time,
the terminals operable as the controller each transmit a test signal to other terminals,
a terminal having received the test signal issues acknowledgment of receipt of the test signal to the terminal having transmitted the test signal,
each of the terminals operable as the controller is configured to measure an error rate from a communicating terminal using the test signal and transmit a measured value to other terminals operable as the controller,
a communication speed of a certain level or higher is required between a first terminal and a second terminal among the terminals operable as the controller, and
the first terminal or the second terminal transmits the periodic signal and acquire controller authorization if the error rate measured by the first terminal or the error rate measured by the second terminal, whichever is higher, is lower than a predetermined upper-limit error rate and the error rate measured by the terminal itself is lower than the error rate measured by the controller.

7. A power line communication system in which a plurality of terminals perform communication via a power line,
wherein
two or more of the plurality of terminals are terminals operable as a controller that outputs a periodic signal,
only one of the terminals operable as a controller serves as the controller at a time,
the terminals operable as the controller each transmit a test signal to other terminals,
a terminal having received the test signal issues acknowledgment of receipt of the test signal to the terminal having transmitted the test signal,
each of the terminals operable as the controller is configured to measure a reception speed of a signal from a communicating terminal using the test signal and transmit a measured value to other terminals operable as the controller,
a communication speed of a certain level or higher is required between a first terminal and a second terminal among the terminals operable as the controller, and
the first terminal or the second terminal transmits the periodic signal and acquires controller authorization if the reception speed measured by the first terminal or the reception speed measured by the second terminal, whichever is lower, is equal to or higher than a predetermined upper-limit reception speed and the reception speed measured by the terminal itself is lower than the reception speed measured by the controller.

8. The system of claim 1, wherein the test signal is issued next after a lapse of a fixed time from last issuance.

9. The system of claim 6, wherein the test signal is issued next after a lapse of a fixed time from last issuance.

10. The system of claim 7, wherein the test signal is issued next after a lapse of a fixed time from last issuance.

11. The system of claim 1, wherein the test signal is issued when the number of terminals joining a network has changed.

12. The system of claim 6, wherein the test signal is issued when the number of terminals joining a network has changed.

13. The system of claim 7, wherein the test signal is issued when the number of terminals joining a network has changed.

14. The system of claim 1, wherein the test signal is issued when a terminal among terminals joining a network other than the controller has failed to receive a signal from the controller for a fixed time or longer.

15. The system of claim 6, wherein the test signal is issued when a terminal among terminals joining a network other than the controller has failed to receive a signal from the controller for a fixed time or longer.

16. The system of claim 7, wherein the test signal is issued when a terminal among terminals joining a network other than the controller has failed to receive a signal from the controller for a fixed time or longer.

17. The system of claim 14, wherein a terminal that has communicated with the terminal having issued the test signal within a fixed time does not issue acknowledgment of receipt of the test signal.

18. The system of claim 15, wherein a terminal that has communicated with the terminal that has issued the test signal within a fixed time does not issue acknowledgment of receipt of the test signal.

19. The system of claim 16, wherein a terminal that has communicated with the terminal that has issued the test signal within a fixed time does not issue acknowledgment of receipt of the test signal.

20. A power line communication device used in a power line communication system in which a plurality of terminals perform communication via a power line, the device being operable as a controller that is a terminal outputting a periodic signal to other terminals, the device comprising:
a test signal transmission section configured to transmit a test signal to other terminals;
an receiving terminal count calculation section configured to calculate an receiving terminal count that is the number of terminals with which the device can communicate based on responses to the test signal from communicating terminals;
an receiving terminal count transmission section configured to transmit the receiving terminal count to other terminals;
a controller receiving terminal count hold section configured to hold the receiving terminal count transmitted by a terminal that is the current controller;
a controller authorization acquisition section configured, when the device is not the controller, to compare the receiving terminal count held in the controller receiving terminal count hold section to the receiving terminal count calculated in the communicating terminal calculation section, and, if the receiving terminal count calculated in the communicating terminal calculation section is larger than that held in the controller receiving terminal count hold section as a result of the comparison, generate a controller change request signal requesting that the device itself should be the controller; and
a transmission section configured to transmit the periodic signal based on the controller change request signal.

21. The device of claim 20, further comprising:
a reception state calculation section configured to measure an average of reception speeds of signals from communicating terminals, or an average of logarithms of the reception speeds, using the test signal, and hold a measured value,
wherein
when the receiving terminal count held in the controller receiving terminal count hold section is the same as the receiving terminal count calculated in the receiving terminal count calculation section, the controller authorization acquisition section compares the value held in the own reception state calculation section to the value held in the reception state calculation section of the terminal currently serving as the controller, and generates the controller change request signal if the value held in the own reception state calculation section is larger than the value held in the reception state calculation section of the controller.

22. The device of claim 20, further comprising:
a reception state calculation section configured to measure a lowest reception speed of signals from communicating terminals using the test signal and hold a measured value, wherein
when the receiving terminal count held in the controller receiving terminal count hold section is the same as the receiving terminal count calculated in the receiving terminal count calculation section, the controller authorization acquisition section compares the value held in the own reception state calculation section to the value held in the reception state calculation section of the terminal currently serving as the controller, and generates the controller change request signal if the value held in the own reception state calculation section is larger than the value held in the reception state calculation section of the controller.

23. The device of claim 20, further comprising:
a reception state calculation section configured to measure an average of error rates from communicating terminals, or an average of logarithms of the error rates, using the test signal, and hold a measured value,
wherein
when the receiving terminal count held in the controller receiving terminal count hold section is the same as the receiving terminal count calculated in the receiving terminal count calculation section, the controller authorization acquisition section compares the value held in the own reception state calculation section to the value held in the reception state calculation section of the terminal currently serving as the controller, and generates the controller change request signal if the value held in the own reception state calculation section is smaller than the value held in the reception state calculation section of the controller.

24. The device of claim 20, further comprising:
a reception state calculation section configured to measure a highest error rate from communicating terminals using the test signal and hold the measured value, wherein
when the receiving terminal count held in the controller receiving terminal count hold section is the same as the receiving terminal count calculated in the receiving terminal count calculation section, the controller authorization acquisition section compares the value held in the own reception state calculation section to the value held in the reception state calculation section of the terminal currently serving as the controller, and generates the controller change request signal if the value held in the own reception state calculation section is smaller than the value held in the reception state calculation section of the controller.
